(19) United States
(12) Patent Application Publication
(10) Pub. No.: US 2017/0159906 A1
(43) Pub. Date: Jun. 8, 2017

(54) LENS ARRAY PANEL

(71) Applicant: ProRadiant Opto. Co., Ltd., Taoyuan (TW)

(72) Inventors: CHAO-PING WANG, Taoyuan (TW); GWO-JUH TZENG, Taoyuan (TW)

(21) Appl. No.: 15/361,612

(22) Filed: Nov. 28, 2016

(30) Foreign Application Priority Data
Dec. 2, 2015 (TW) 104219377

(51) Int. Cl. F21V 5/00; G02B 3/00; G02B 1/04

(52) U.S. Cl. CPC F21V 5/004; G02B 1/041; G02B 3/0043

(57) ABSTRACT

A lens array panel includes a substrate and plural microlens structures periodically arranged on a side of the substrate, and the substrate and the microlens structure are integrally formed. The substrate and the microlens structure has a contact surface which is either a convex surface or a concave surface, so that the lens array panel have either a light scattering function or a light condensing function. The lens array panel formed by the substrate with a non-planar (convex or concave) surface has a light scattering or condensing function to achieve effects of adjusting the angle and illumination of the light and minimizing the use of lighting equipments for the same region.

### FIELD OF INVENTION

The present invention relates to a lens array panel, in particular to the lens array panel having a substrate of a different thickness or shape and a microlens structure of a different volume and mainly composed of the substrate with a non-planar (convex or concave) surface to produce a light scattering or condensing function effectively and achieve the effects of adjusting the angle and illumination of the light and minimizing the use of lighting equipments per unit area in the same region.

### BACKGROUND OF INVENTION

### Description of the Related Art

Lens array (also know as fly eyes) is a lens module comprised of a plurality of microlens structures and it has a major function of utilizing light efficiently in order to homogenize light and energy. With reference to FIGS. 1 and 2 for a cross-sectional view of a conventional light emitting device with a lens array and a perspective view of a conventional lens array panel respectively, the conventional light emitting device comprises a lamp panel (100), a light emitting element (200) installed on the lamp panel (100), and a lens array panel (300) installed on the light emitting element (200). The lens array panel (300) comprises a substrate (31), and a plurality of microlens structures (32) installed on a surface of the substrate (31), wherein the lens array panel (300) is integrally formed on the substrate (31) in a substantially planar configuration and has a plurality of periodically arranged microlens structures (32) and capable of utilizing light efficiently in order to homogenize light and energy. However, the scope of light applications is broad, so that the conventional light emitting device with the lens array no longer can adjust the angle and illumination of the light effectively. For comprehensive applications, it is necessary to use more lighting equipments per unit area in the same region, and thus incurring a higher hardware cost. Therefore, finding a way to adjust the angle and illumination of the light by hardware improvement and achieve the effect of minimizing the use of lighting equipments for the same region demands immediate attention and feasible solutions.

### SUMMARY OF THE INVENTION

In view of the aforementioned drawbacks of the prior art, the inventor of the present invention based on years of experience in the related industry to conduct extensive research and experiment, and finally developed a lens array panel in accordance with the present invention to overcome the drawbacks of the prior art.

Therefore, it is a primary objective of the present invention to provide a lens array panel having a substrate of a different thickness or shape and a microlens structure of a different volume, and the lens array panel is formed by the substrate with a non-planar (convex or concave) surface to provide a light scattering or condensing function and adjust the angle and illumination of the light, so as to achieve the effect of minimizing the use of light equipments for the same region.

To achieve the aforementioned and other objectives, the present invention provides a lens array panel, comprising a substrate, and plurality of microlens structures periodically arranged on a side of the substrate, wherein the substrate and the microlens structures are integrally formed, characterized in that the substrate and the microlens structures have a contact surface which is a convex surface or a concave surface, so that the lens array panel has either a light scattering function or a light condensing function.

In an embodiment of the present invention, the substrate and the microlens structures are integrally formed and made of polymethylmethacrylate (PMMA) or polycarbonate (PC).

In an embodiment of the present invention, if the contact surface of the substrate and the microlens structures is a convex surface, the lens array panel will have a light scattering function.

In an embodiment of the present invention, the substrate has a section in a hemispherical, triangular, trapezoidal, pentagonal or polygonal shape.

In an embodiment of the present invention, the substrate has a section in a two-hemispherical shape or a half-hemispherical shape.

In an embodiment of the present invention, the microlens structures are formed by configuring a plurality of first microlens and a plurality of second microlens alternately.

In an embodiment of the present invention, the first microlens have a volume equal to or unequal to the volume of the second microlens.

In an embodiment of the present invention, if the contact surface of the substrate and the microlens structure is a concave surface, then the lens array panel will have a light condensing function.

In an embodiment of the present invention, the substrate has a section in a hemispherical shape or at least one half-hemispherical shape.

The lens array panel of the present invention comprises a substrate with a non-planar (convex or concave) surface and a plurality of microlens structures integrally formed with the substrate, and the lens array panel can provide a light scattering or condensing function according to the user or environmental requirements for the light emitted from the bottom of the lens array panel. In addition, the lens array panel of the present invention can effectively adjust and optimize the angle and illumination of the light emitted from the bottom of the lens array panel by changing the thickness and shape of the substrate, so as to achieve the effects of minimizing the use of light equipments for the same region, and saving the material cost of the light emitting devices of the lens array panel.

### BRIEF DESCRIPTION OF THE DRAWINGS

FIG. 1 is a cross-sectional view of a conventional light emitting device with a lens array;

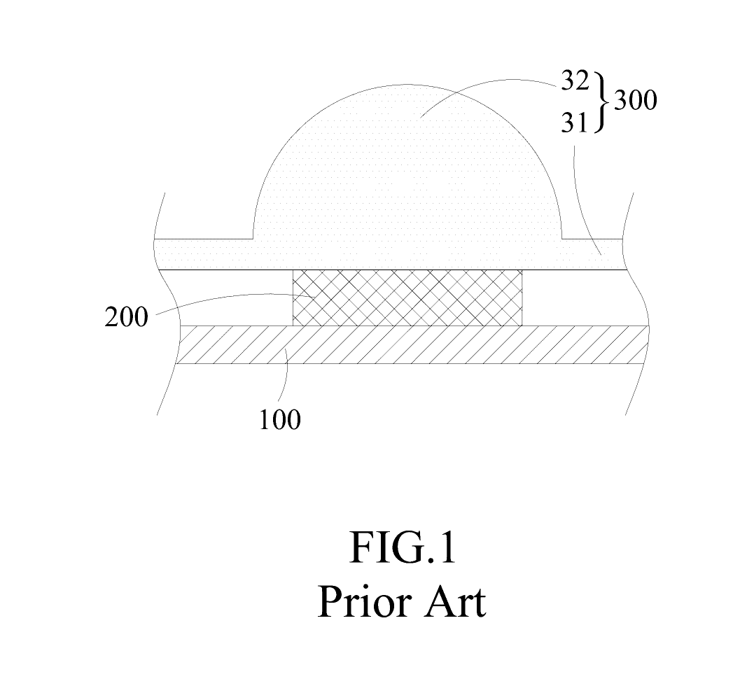

FIG. 2 is a perspective view of a conventional light emitting device with a lens array;

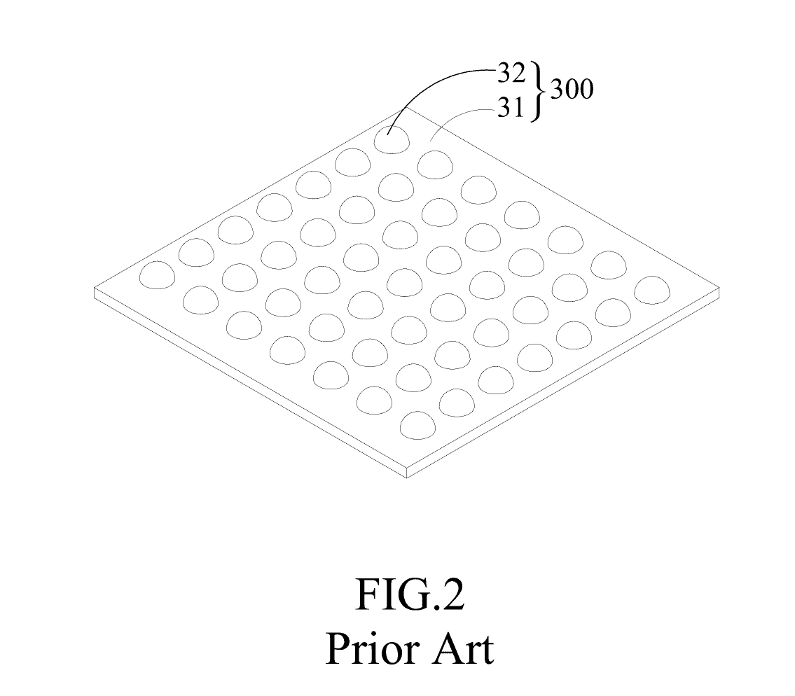

FIG. 3 is a perspective view of a lens array panel in accordance with a first preferred embodiment of the present invention;

FIG. 4 is a cross-sectional view of a lens array panel in accordance with the first preferred embodiment of the present invention;

FIG. 5 is a cross-sectional view of a lens array panel in accordance with a second preferred embodiment of the present invention;

FIG. 6 is a cross-sectional view of a lens array panel in accordance with a third preferred embodiment of the present invention;

FIG. 7 is a cross-sectional view of a lens array panel in accordance with a fourth preferred embodiment of the present invention;

FIG. 8 is a cross-sectional view of a lens array panel in accordance with a fifth preferred embodiment of the present invention;

FIG. 9 is a cross-sectional view of a lens array panel in accordance with a sixth preferred embodiment of the present invention;

FIG. 10 is a cross-sectional view of a lens array panel in accordance with a seventh preferred embodiment of the present invention;

FIG. 11 is a cross-sectional view of a lens array panel in accordance with an eighth preferred embodiment of the present invention;

FIG. 12 is a cross-sectional view of a lens array panel in accordance with a ninth preferred embodiment of the present invention; and

FIG. 13 is a cross-sectional view of a lens array panel in accordance with a tenth preferred embodiment of the present invention.

### DESCRIPTION OF THE PREFERRED EMBODIMENTS

The above and other objects, features and advantages of this disclosure will become apparent from the following detailed description taken with the accompanying drawings.

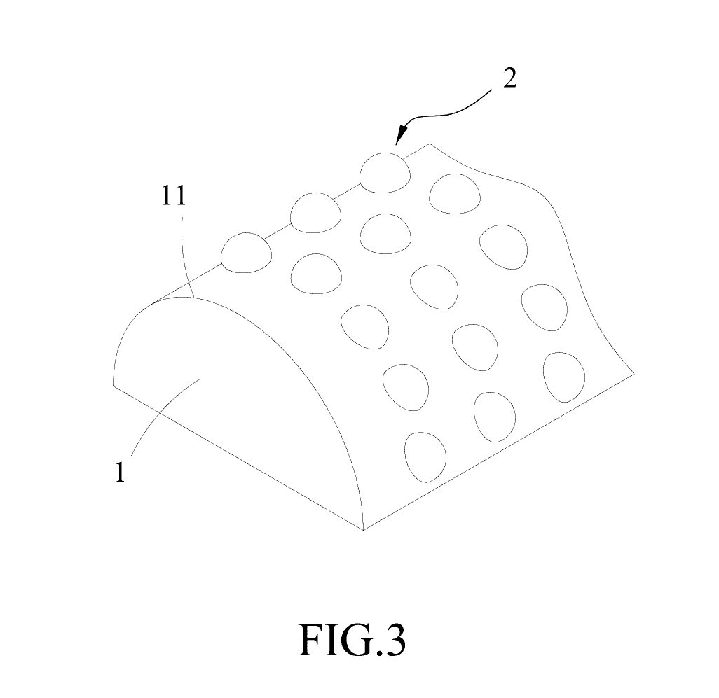

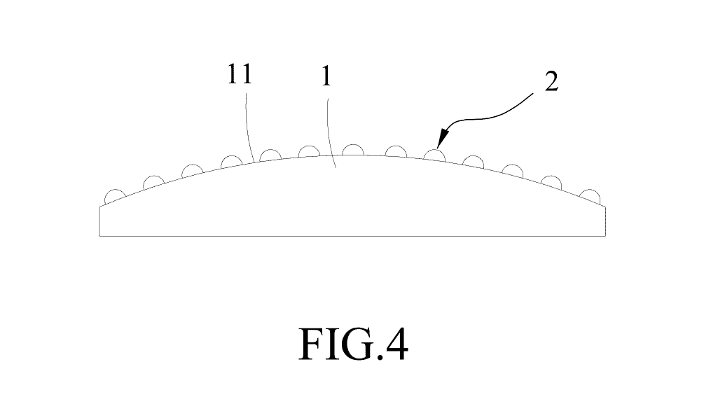

With reference to FIGS. 3 and 4 for a schematic view and a cross-sectional view of a lens array panel in accordance with the first preferred embodiment the present invention respectively, the lens array panel comprises a substrate (1), and a plurality of microlens structures (2) arranged on a side of the substrate (1), wherein the substrate (1) and the microlens structures (2) are integrally formed, characterized in that the substrate (1) and the microlens structures (2) have a contact surface (11) which is a convex surface or a concave surface, so that the lens array panel has either a light scattering function or a light condensing function.

In addition, the substrate (1) and the microlens structure (2) are integrally formed and made of polymethylmethacrylate (PMMA) or polycarbonate (PC).

In addition, if the contact surface (11) of the substrate (1) and the microlens structures (2) is a convex surface, the lens array panel will have a light scattering function. In FIGS. 3 and 4, the substrate (1) has a section in a hemispherical, triangular, trapezoidal, pentagonal or polygonal shape. In FIGS. 3 and 4, the substrate (1) has a section in a convex hemispherical shape. In other words, the contact surface of the substrate (1) and the microlens structure (2) is substantially in an arc shape.

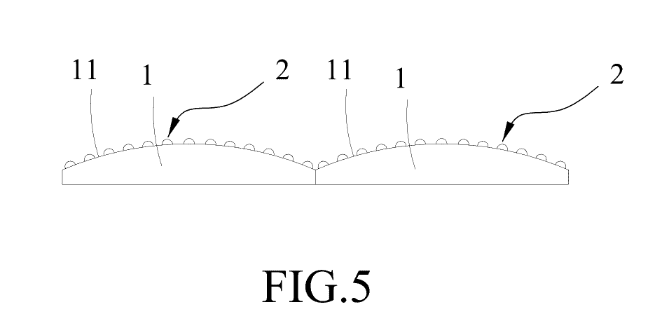

With reference to FIG. 5 for a cross-sectional view of a lens array panel in accordance with the second preferred embodiment of the present invention, the lens array panel of the second preferred embodiment comprises a substrate (1) formed by combining two of the aforementioned convex hemispherical shapes, and a plurality of microlens structures (2) formed on the surface (11) to produce a lens array panels with the light scattering function.

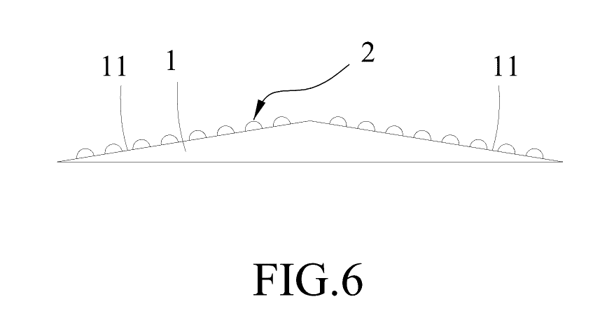

With reference to FIG. 6 for a cross-sectional view of a lens array panel in accordance with the third preferred embodiment of the present invention, the lens array panel of the third preferred embodiment comprises a substrate (1) with a section in a convex triangular shape, and a plurality of microlens structures (2) formed on a surface (11) to produce a lens array panel with the light scattering function.

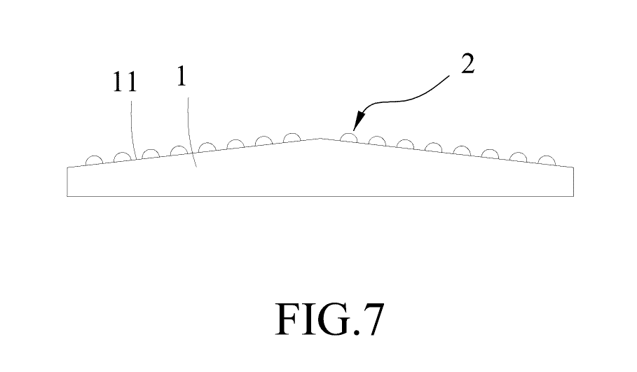

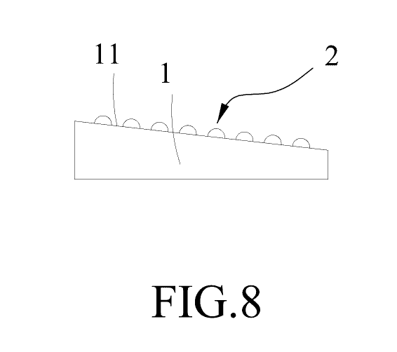

With reference to FIGS. 7 and 8 for a cross-sectional view of a lens array panel in accordance with the fourth and fifth preferred embodiments of the present invention respectively, the substrate (1) of the fourth preferred embodiment has a section in a convex pentagonal shape, and the substrate (1) of the fifth preferred embodiment has a section in half of a convex pentagonal shape to form a trapezoidal shape, and a plurality of microlens structures (2) formed on a surface (11) to form a lens array panel with the light scattering function.

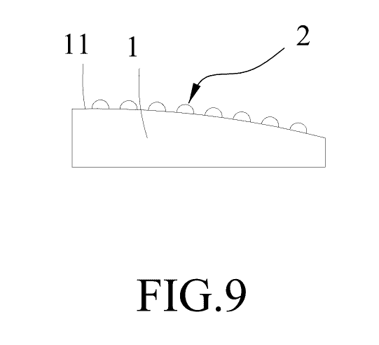

With reference to FIG. 9 for a cross-sectional view of a lens array panel in accordance with the sixth preferred embodiment of the present invention, the lens array panel of the sixth preferred embodiment comprises a substrate (1) with a section in a half of the convex triangular shape, and a plurality of microlens structures (2) formed on a surface (11) to produce a lens array panel with the light scattering function.

In addition, if the contact surface (11) of the substrate (1) and the plurality of microlens structures (2) is a concave surface, then the lens array panel will have a light condensing function.

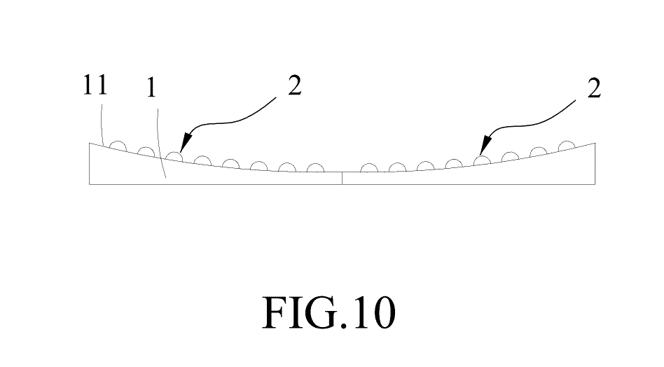

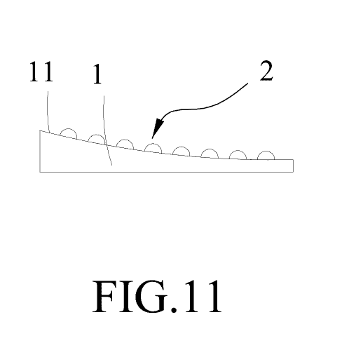

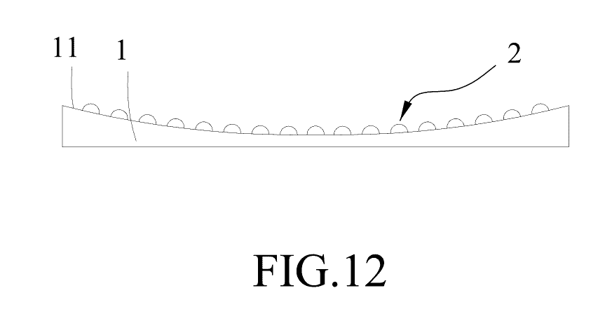

With reference to FIGS. 10 to 12 for the cross-sectional views of a lens array panel in accordance to the seventh to ninth preferred embodiments of the present invention respectively, the substrate (1) of the seventh preferred embodiment has a section in a concave arc shape, and a plurality of microlens structure (2) formed on the surface (11) to produce a lens array panel with the light condensing function. The substrate (1) of the eighth preferred embodiment has a section in half of the aforementioned concave arc shape. The substrate (1) of the ninth preferred embodiment has a section in the shape of two combined substrates (1) of the eighth preferred embodiment and a plurality of microlens structures (2) formed on the surface (11) to produce a lens array panel with the light condensing function.

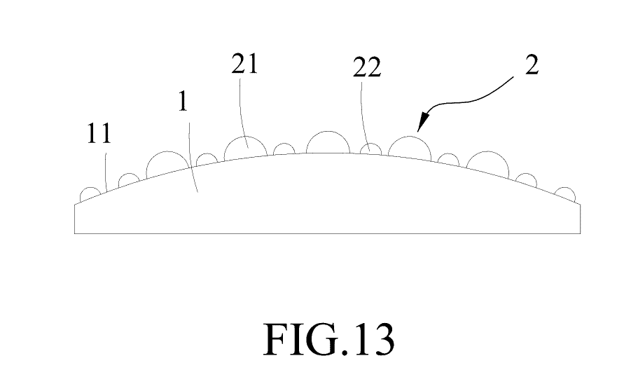

With reference to FIG. 13 for a lens array panel in accordance with the tenth preferred embodiment of the present invention, the microlens structure (2) is formed by configuring a plurality of first microlens (21) and a plurality of second microlens (22) alternately, and the first microlens (21) have a volume equal to or unequal to the volume of the second microlens (22. In the tenth preferred embodiment of the present invention, the first microlens (21) have a volume greater than the volume of the second microlens (22).

The objects, features and effects of the present invention will become apparent from the above detailed description of the preferred embodiments taken with the accompanying drawings. These embodiments are provided for the purpose of illustrating the present invention, but not intended for limiting the scope of the invention. When a user needs lighting, the lens array panel of the present invention may be installed onto a light emitting device to provide a light scattering or condensing function according to the user or environmental requirements for the light emitted from the bottom of the lens array panel. Like the structure of the conventional light emitting device having a lens array, a light emitting element is installed onto a lamp panel, and then a lens array panel is installed to the light emitting element to form the light emitting device having a lens array, wherein the lens array panel comprises a substrate (1), and a plurality of microlens structures (2) periodically arranged on a side of the substrate (1), wherein the substrate (1) and the microlens structure (2) are integrally formed, and the substrate (1) and the microlens structures (2) are integrally formed and made of polymethylmethacrylate (PMMA) or polycarbonate (PC), and the contact surface (11) of the substrate (1) and the microlens structure (2) is in a convex arc shape to produce a lens array panel with the light scattering function. The lens array panel of the present invention can effectively adjust and optimize the angle and illumination of the light emitted from the bottom of the lens array panel by changing the thickness and shape of the substrate, so as to achieve the effects of minimizing the use of light equipments for the same region, and saving the material cost of the light emitting devices of the lens array panel.

Compared with the prior art and the conventional products, the present invention has the following advantages:

1. The lens array panel of the present invention is formed by a substrate with a non-planar (convex or concave) surface and a plurality of microlens structures integrally formed with the substrate to provide a light scattering or condensing function for the light emitted from the bottom of the lens array panel according to the user or environmental requirement.

2. The lens array panel of the present invention can effectively adjust and optimize the angle and illumination of the light emitted from the bottom of the lens array panel by changing the thickness and shape of the substrate, so as to achieve the effects of minimizing the use of light equipments for the same region, and saving the material cost of the light emitting devices of the lens array panel.

In summation of the description above, the lens array panel of the present invention definitely achieves the expected effects as disclosed in this specification and complies with patent application requirements, and is thus duly filed for patent application.

While the invention has been described by means of specific embodiments, numerous modifications and variations could be made thereto by those skilled in the art without departing from the scope and spirit of the invention set forth in the claims.

What is claimed is:

1. A lens array panel, comprising a substrate, and a plurality of microlens structures arranged on a side of the substrate, wherein the substrate and the microlens structures are integrally formed, characterized in that the substrate and the microlens structures have a contact surface which is a convex surface or a concave surface, so that the lens array panel has either a light scattering function or a light condensing function.

2. The lens array panel of claim 1, wherein the substrate and the microlens structures are integrally formed and made of a material selected from the group consisting of polymethylmethacrylate (PMMA) and polycarbonate (PC).

3. The lens array panel of claim 1, wherein if the contact surface of the substrate and the microlens structures is a convex surface, the lens array panel will have a light scattering function.

4. The lens array panel of claim 3, wherein the substrate has a section in a shape selected from the group consisting of a hemispherical shape, a triangular shape, a trapezoidal shape, a pentagonal shape and a polygonal shape.

5. The lens array panel of claim 4, wherein the substrate has a section in a shape selected from the group consisting of a two-hemispherical shape or a half-hemispherical shape.

6. The lens array panel of claim 3, wherein the microlens structures are formed by configuring a plurality of first microlens and a plurality of second microlens alternately.

7. The lens array panel of claim 6, wherein the first microlens has a volume equal to or unequal to the volume of the second microlens.

8. The lens array panel of claim 3, wherein if the contact surface of the substrate and the microlens structures is a concave surface, the lens array panel will have a light condensing function.

9. The lens array panel of claim 8, wherein the substrate has a section in the shape selected from the group consisting of a hemispherical shape or at least one half-hemispherical shape.
